(19) United States
(12) Patent Application Publication
(10) Pub. No.: US 2007/0220271 A1
(43) Pub. Date: Sep. 20, 2007

(54) Online creation and delivery of cryptographically verifiable one-time password tokens

(76) Inventor: Eric Chun Wah Law, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/377,079

(22) Filed: Mar. 15, 2006

(51) Int. Cl. H04L 9/00

(52) U.S. Cl. 713/185

(57) ABSTRACT

A system and method are configured for online creation and delivery of tokens. In one embodiment, a first party sends a request for token generation to a second party. The second party sends a retrieval link to the first party through a first network. The first party sends a retrieval request following the retrieval link to the second party. Upon receiving the retrieval request, the second party generates the token and sends through a second network to the first party.

### BACKGROUND

1. Field of Art

The present invention generally relates to the field of electronic communications, and more specifically, to secured online delivery of electronic tokens.

2. Description of the Related Art

The Internet has demonstrated exponential growth in the last 10 years. Today, millions of users are relying on the Internet to communicate, to work and to do business. However, unsecured network communications would provide hackers tremendous opportunities to access unauthorized information (e.g., identity information, sensitive financial information) and to conduct fraudulent transactions. Adequate security measures to prevent unauthorized network access are necessary to prevent such unauthorized access and fraudulent transactions.

One common security measure is the use of passwords to prevent unauthorized network access. However, the most common form of passwords is static, which could be easily hacked using tools such as viruses, spy-wares, proxies and network analyzers. To help address the vulnerability of static password, various dynamic password or “one-time password” mechanisms have emerged. A one-time password is a password that can only be used once such that it is computationally infeasible for an unauthorized third party to predict the next password when the current one is compromised.

One-time passwords commonly are generated by a security device or mechanism referred to as a token. The token could be a standalone separate physical computing device (also called simply a hardware security token) or may be an application or applet running on a standalone physical computing device (also called simply a software security token). The token in either form is able to generate a one-time password driven by internal token secrets and parameters. The parameters include variables such as the current time or a sequence number. The sequence number could be internally generated from the token parameters. Generally in a one-time password scheme, a host system is equipped with an authentication server that has access to the same sets of token secrets and parameters as the users' tokens that are going to be authenticated. When a token is authenticated, the token parameters such as the sequence number would be synchronized automatically. In order for the generated one-time password system to be effective, the token along with its embedded token secrets and parameters must be protected from unauthorized access and unnecessary network exposure.

Token secrets and parameters are usually embedded into the hardware security token by the token vendors at the time of manufacture to protect them from leakage. While this approach secures the token secrets within the tamper-resistant hardware security tokens, it may not be entirely secure if the token secrets are compromised during manufacturing or at deployment of the devices. For example, without a proper security administration procedure, the medium holding the token secrets for installation into the authentication servers (e.g., CD-ROM, hard disk, tape, etc.) are subject to hacker access. Furthermore, if the token secrets and parameters of a hardware security token are compromised or are suspected to have been compromised, the token must be physically destroyed and replaced with a new one. This results in extra costs and usage delays.

In the case of software security token, the conventional approach is to generate token secrets and parameters in the authentication servers and deliver them to a token user through traditional communication means, for example, over the phone, by email, or by postal service. While this approach secures generation of token secrets and parameters in the authentication servers, the delivery methods are themselves vulnerable. For example, emails and phone calls are subject to unauthorized interception and monitoring. Furthermore, it is difficult to educate token users to fully comply with preventive security practice, such as destroying or securely storing the medium holding the token secrets and parameters once they have been deployed into the tokens. In cases even when users have destroyed the medium holding the token secrets, such as deleting an email, a copy of the email containing the token secrets and parameters might be stored in the exchange server or backup devices, which still provides hackers opportunities to exploit the token secrets and parameters.

Therefore, there is a need for a system and process that securely generate and deliver token secrets for use in electronic communications.

### SUMMARY

The present invention includes a system and a method for securely creating and delivering token secrets and parameters between a first party and a second party. In an embodiment, both parties have access to two separate networks. The first party sends a request to generate token secrets and parameters to the second party through a first network. The second party sends a retrieval link to the first party through a second network. Using the retrieval link, the first party sends a token download request to the second party through either network. The second party creates the token with embedded token secrets and parameters and sends the token to the first party through either network upon receiving the token download request with the retrieval link. In one embodiment, the network communication links between the first party and the second party may be further protected by the Secure Socket Layer (SSL) protocol or other secure communication means as needed.

In another embodiment, a system (and a method) securely creates and delivers token secrets and parameters between a first party and a second party. Once more, both parties have access to two separate networks. The first party sends a request to generate the token secrets and parameters to the second party through a first network. The second party creates a pair of public and private keys, and sends the private key along with a retrieval link to the first party through a second network. The first party sends a token download request for the token secrets and parameters with the retrieval link to the second party through either network. The second party creates a token with embedded token secrets and parameters, encrypts the token with the public key, and sends the encrypted token to the first party through either network upon receiving the token download request with the retrieval link. Note that the pair of public and private keys are unique for a single use and thus the ‘public’ key is also a secret.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The disclosed embodiments have other advantages and features which will be more readily apparent from the following detailed description and the appended claims, when taken in conjunction with the accompanying drawings, in which:

FIG. 1 illustrates one embodiment of an online token creation and delivery framework in accordance with the present invention.

FIG. 2 illustrates one embodiment of a process for online token creation, delivery, and revocation in accordance with the present invention.

FIG. 3 illustrates one embodiment of a process for a server to create, deliver, and revoke a token, in accordance with a preferred embodiment of the invention.

### DETAILED DESCRIPTION OF THE EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

The Figures (FIGS.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles described herein.

The description herein provides a system and a method for online creation and delivery of cryptographically verifiable one-time password tokens. For ease of understanding, the description made is in the context of electronic communication between a user and a computing server. However, the principles described herein are equally applicable for any transaction between parties, e.g., a buyer and a seller or a login requester and secured web site operator, and other applications between parties as noted above.

1. Online Creation and Delivery of One-Time Password Tokens System

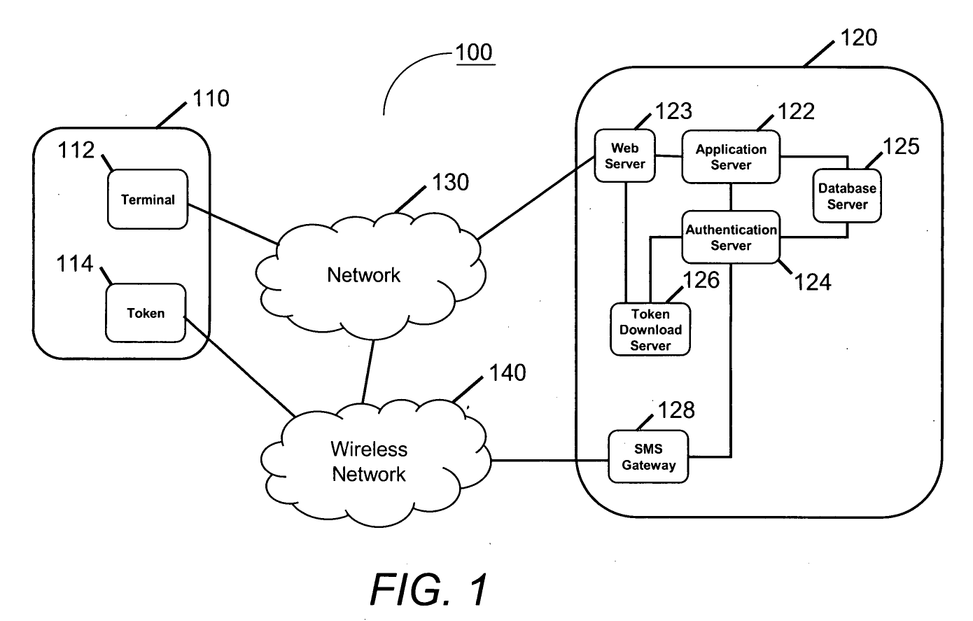

FIG. 1 illustrates one embodiment of an online token creation and delivery system architecture 100 in accordance with the present invention. The system 100 includes a first party 110 and a second party 120. The first party 110 and the second party 120 are communicatively coupled through a network 130 and a wireless network 140.

In one embodiment, the first party 110 may comprise a terminal 112 and a token 114, of which each includes a processor, a controller, or other intelligence. The terminal 112 is a computing device equipped and configured to communicate with the second party 120 through the network 130. Examples of the terminal 112 include a personal computer, a laptop computer, or a personal digital assistant (PDA) with a wired or wireless network interface and access. The token 114 is a security mechanism that provides one-time passwords. The token 114 may be a standalone separate physical device or may be an application or applet running on a separate standalone physical device (e.g., a mobile phone or a PDA) with wireless or cellular access. For ease of discussion, the token 114 is assumed to be an application residing in a mobile phone. The token 114 is equipped and configured to communicate with the second party 120 through the wireless network 140. The terminal 112 and the token 114 are normally physically separated. However, in certain scenarios, there may be a need to transfer data from the terminal 112 to the token 114 and the two devices may be connected by locally wired or wireless connection on a temporary basis for a short period of time.

The network 130 may be a wired or wireless network. Examples of the network 130 include the Internet, an intranet, or a combination thereof. The wireless network 140 is a network different from the network 130. Examples of the wireless network 140 include a Global System for Mobile communication network (also called GSM network), a Code Division Multiple Access network, a Time Division Multiple Access network, a General Packet Radio Service network, a Wideband Code Division Multiple Access network, a Time Division Synchronous Code Division Multiple Access network, a Universal Mobile Telephone System, or a combination thereof. The network 130 and the wireless network 140 are connected by some gateway devices. It is noted that the terminal 112 and the token 114 of the first-party system 110 are structured to include a processor, memory, storage, network interfaces, and applicable operating system and other functional software (e.g., network drivers, communication protocols, etc.).

The second party 120 includes a web server 123, an application server 122, a database server 125, an authentication server 124, a token download server 126, and a Short Message Service gateway (also called SMS gateway) 128. The web server 123 communicatively couples the network 130, the application server 122, and the token download server 126. The application server 122 communicatively couples the web server 123, the database server 125, and the authentication server 124. The database server 125 communicatively couples the application server 122 and the authentication server 124. The authentication server 124 communicatively couples the application server 122, the database server 125, the token download server 126, and the SMS gateway 128. The token download server 126 communicatively couples the web server 123 and the authentication server 124. The SMS gateway 128 communicatively couples the wireless network 140 and the authentication server 124.

The web server 123 is the front end to the application server 122 and the token download server 126, and functions as a communication gateway into the second party 120. It is noted that the web server 123 is not limited to a web server, but rather can be any communication gateway that appropriately interfaces the network 130 and manages communication, e.g., a corporation virtual private network front end, a cell phone system communication front end, or a point of sale communication front end. For ease of discussion, this front end will be referenced as the web server 123 of the application server 122 and the token download server 126, although the principles disclosed are applicable to a broader array of communication gateways.

The application server 122 manages communications relating to user profile and corresponding token between the first party 110 and the authentication server 124 through the web server 123 and the network 130. The authentication server 124 is configured to create, manage, and revoke tokens and token secrets, to embed token secrets and parameters into tokens, to generate one-time passwords, and to verify received one-time passwords. The Database server 125 is configured to store and manage tokens, token secrets and parameters, and user profiles. The token download server 126 manages token download requests from the first party 110 through the web server 123 and the network 130. The SMS gateway 128 manages communications between the first party 110 and the authentication server 124 through the wireless network 140.

It is noted that the second-party 120 can be configured on one or more conventional computing systems having a processor, memory, storage, network interfaces, peripherals, and applicable operating system and other functional software (e.g., network drivers, communication protocols, etc.). In addition, it is noted that the servers 122, 123, 124, 125, and 126, and gateway 128 are logically configured to function together and can be configured to reside on one physical system or across multiple physical systems.

In one embodiment, operation of the online token creation and delivery system 100 can be described as follows. The first party 110 sends (or transmits) a request for token to the second party 120 through the terminal 112, the network 130, the web server 123, and the application server 122 in order to obtain a software package of token application and dataset (token secrets and parameters) for installation into the token 114. For ease of discussion, the software package of token application and dataset is also referred to as the “token” with an embedded token application and token dataset. The network address (the mobile phone number of the token 114 or other wireless subscriber identification) of the first party 110 has been pre-registered with the second party 120 before the token creation and delivery request is made. Pre-registration is usually done through over-the-counter service or online personal information update service offered by the second party 120.

The application server 122 passes the request to the authentication server 124. In one embodiment, the application server 122 has access to the database server 125 which stores user profiles, and the application server 122 sends a query to the database server 125, retrieves the user profile corresponding to the first party 110, and passes the request to the authentication server 124 along with the retrieved user profile.

Upon receiving the request to generate a token, the authentication server 124 creates a new token database record for the user corresponding to the first party 110 in the database server 125. According to the pre-registered network address (i.e. mobile phone number) of the first party 110, the authentication server 124 then sends a notification message with a retrieval link associated with the created token database record to the first party 110 through the SMS gateway 128, the wireless network 140, and the token 114. In one embodiment, the notification message is sent under the Short Message Service (SMS) protocol over the wireless network 140, for example a digital GSM network. In some embodiments, the retrieval link expires after a single use. If the link is not used within a predetermined time period, the link will expire too. The advantage of sending the notification message through SMS is that it ensures that only the intended party 110 can receive the notification message through the token 114. Furthermore, the expiration of the retrieval link after a single use or a predetermined time period reduces the exposure of a usable retrieval link to unauthorized parties in the network 140.

Upon receiving the notification message, the first party 110 sends a retrieval request to the authentication server 124 following the retrieval link in the notification message. In some embodiments, this request is made through the terminal 112, the network 130, and the web server 123 to the token download server 126. In some other embodiments, this request is made through the token 114 via the wireless network 140, the network 130, and the web server 123 to the token download server 126. The token download server 126 then submits the retrieval request to the authentication server 124. In one embodiment, the retrieval link expires after a single use. Thus, once the authentication server 124 receives the retrieval link from a party, the authentication server 124 will not respond to subsequent requests associated with the same retrieval link. In other embodiments, the authentication server 124 determines whether the retrieval link expires, and it only generates a token if the retrieval link has not expired.

The authentication server 124 generates a software package of new token application and dataset including a set of token secrets and parameters. In one embodiment, token secrets comprise cryptographic keys, random numbers, control vectors and other data (e.g., secrets) such as additional numerical values used as additional parameters for computation and cryptographic operations by the newly generated token. In addition, token parameters comprise control parameters, for example, encrypted PIN, a monotonically increasing or decreasing sequence number, optional transaction challenge code, transaction digests and usage statistics. In some embodiments, the token parameters may be dynamic such that they will be updated upon authentication operations.

Generation of the software package of token application and dataset with embedded token secrets and parameters is usually done by packaging a predefined cryptographic algorithm consisting of programmed computational steps and cryptographic operations with a newly generated set of random secrets and parameters. The authentication server 124 then saves the generated token dataset with embedded token secrets and parameters into the corresponding token database record in the database server 125.

The authentication server 124 sends the software package of token application and dataset with embedded token secrets and parameters to the token 114. In some embodiments, the software package of token application and dataset with embedded token secrets and parameters are sent through the token download server 126, the web server 123, the network 130, and the wireless network 140. The network 130 and the wireless network 140 are connected by some gateway devices. In one embodiment, the gateway device is a GPRS/WAP gateway server hosted by the provider of the wireless network 140. In some other embodiments, the software package of token application and dataset with embedded token secrets and parameters are sent through the token download server 126, the web server 123, the network 130, and the terminal 112. The first party 110 then connects the token 114 using a wired or wireless connection and moves the software package of token application and dataset with embedded token secrets and token parameters from the terminal 112 to the token 114 for installation into the memory of the token 114. For security reason, the first party 110 should disconnect the network connection between the terminal 112 and token 114 after successful installation of the software package of token application and dataset into the token 114.

After receiving and installing the software package of token application and dataset with embedded token secrets and parameters, the token 114 will be able to generate one-time passwords using the newly installed software package.

The first party 110 also can request the authentication server 124 to revoke the token secrets. In one embodiment, the revocation request is made through the terminal 112, the network 130, the web server 123, and the application server 122. In another embodiment, the revocation request is made through the token 114 via the wireless network 140, the network 130, the web server 123, and the application server 122. Upon receiving the revocation request, the authentication server 124 removes the corresponding token database record containing the token dataset with embedded token secrets and parameters from the database server 125.

It is noted that in alternative embodiments, the authentication server 124 may generate a pair of public and private keys, and send the private key to the first party 110 along with the notification message. To enhance security during the delivery process, the authentication server 124 encrypts the software package with the public key and delivers the encrypted software package to the first party 110 through the application server 122, the web server 123, the network 130, and the wireless network 140 for installation into the token 114. The token 114 of the first party 110 decrypts the received software package with the private key received in the notification message and installs the decrypted software package into its memory. This variation helps to further ensure the secured delivery of the token through separate deliveries of the private key over the wireless network 140 and the encrypted software package over the network 130.

The configuration described above includes a number of advantages. For example, the authentication server 124 generates the token secrets at the time of token request and the token secrets are locally created within a secure memory environment typically enforced with a tamper-resistant hardware security module (HSM). Since there is no prefabrication of token secrets pending for installation, token generation is deemed secure and there is no exposure risk outside the perimeter of the authentication server 124. Another advantage is secured delivery where nobody could access the generated token secrets without the retrieval link. The retrieval link is sent to the first party 110 through a separate wireless network 140. Hackers cannot access the token secrets without simultaneously eavesdropping both networks, a feat that is deemed quite difficult if not impossible. Thus, even if a malicious party can successfully hack the communication link between the first party 110 and the second party 120 in one of the two networks, the hacker cannot access the token secrets. Another advantage is convenience. A user is not required to carry an additional token device once the token application and dataset is installed into the user's cell phone. As a result, the cell phone effectively becomes a security token.

2. An Example of Online Token Creation and Delivery Process

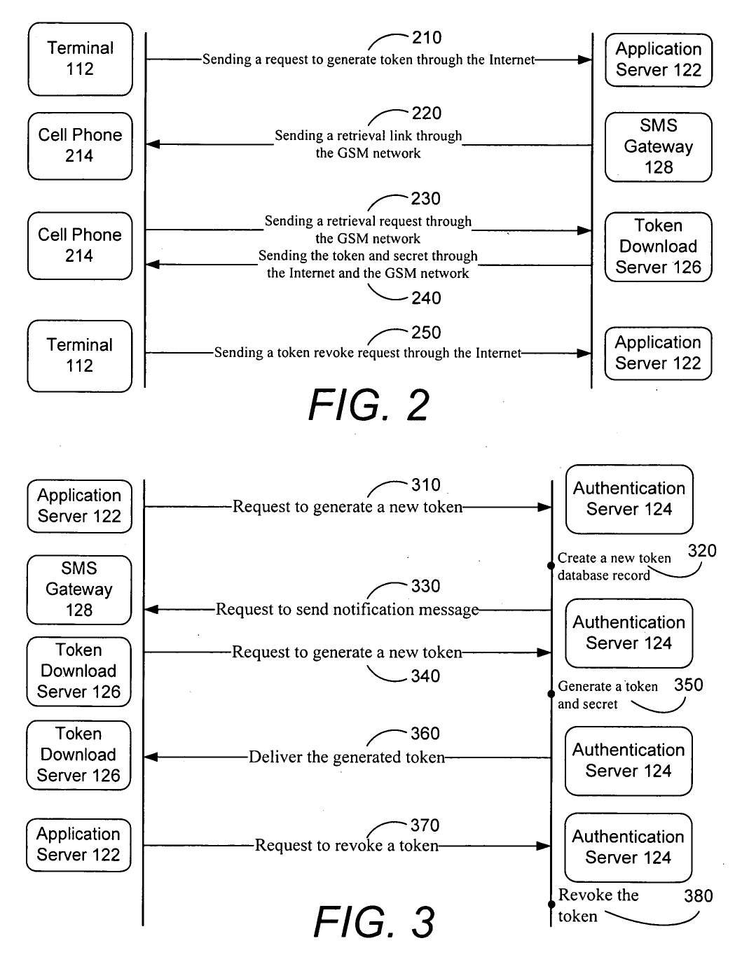

The principles described herein can be further described through an example of an online token creation and delivery process as illustrated in FIGS. 2 and 3. In this example, the processes described with respect to the first and second parties are performed on the respective terminal, servers, gateway, and/or token as previously described. The token 114 in the example is a cell phone 214. Communication between the first and second parties is through the Internet and a GSM network, the Internet is functionally similar to the network 130 and the GSM network is functionally similar to the wireless network 140.

FIG. 2 illustrates one embodiment of a process for online token generation and delivery between the first party 110 and the second party 120. The process involves the terminal 112 and the cell phone 214 on the first party 110 side, and the web server 123, the application server 122, SMS gateway 128, and token download server 126 on the second party 120. For ease of understanding, the web server 123 is not displayed in FIG. 2.

The process starts with the first party 110 sends 210 a request to generate token to the second party 120 through the terminal 112 via the Internet, the web server 123, and the application server 122. The mobile phone number of the cell phone 214 in the GSM network has been pre-registered with the second party 120 before the token generation request is made, and is saved in the database server 125 along with the rest user profile of the first party 110.

Referring to FIG. 3, upon receiving the request to generate token, the application server 122 requests 310 the authentication server 124 to generate a new token. The authentication server 124 responds by creating 320 a new token database record corresponding to the first party 110 in the database server 125, and requests 330 the SMS gateway 128 to send notification message containing a token retrieval link to the cell phone associated with the mobile phone number in the GSM network.

Referring to FIG. 2, upon receiving the notification message from the authentication server 124, the SMS gateway 128 sends 220 the notification message containing the retrieval link to the cell phone 214 of the first party 110 under SMS protocol over the GSM network. Upon receiving the notification message, the cell phone 214 sends 230 a retrieval request to the token download server 126 through the GSM network's GPRS/WAP gateway, the Internet, and the web server 123.

The token download server 126 passes the retrieval request on to the authentication server 124. Turning to FIG. 3, upon receiving the retrieval request, the token download server 126 requests 340 the authentication server 124 to generate a new token. In another embodiment, the first party 110 sends the retrieval request to the token download server 126 through the terminal 112 via the Internet, the web server 123, and the token download server 126, which then passes on the retrieval request to the authentication server 124.

Upon receiving the retrieval request from the token download server 126, the authentication server 124 generates 350 a software package of token application and dataset with embedded token secrets and token parameters. The authentication server then delivers 360 the generated software package to the token download server 126.

Referring to FIG. 2, upon receiving the generated software package with token application and embedded token secrets and parameters, the token download server 126 sends 240 the software package to the cell phone 214 of the first party 110 through the web server 123, the Internet, and the GSM network. In another embodiment, the token download server 126 sends the software package to the terminal 112 through the web server 123 and the Internet. The first party 110 then moves the software package from the terminal 112 to the cell phone 214 through a local wired or wireless connection. Upon receiving and installing the software package, the cell phone 214 can start generating one-time passwords.

In one embodiment, the first party 110 can revoke the current token by sending 250 a token revoke request to the application server 122 through the terminal 112, the Internet, and the web server 123. The application server 122 passes the token revoke request on to the authentication server 124. Turning to FIG. 3, upon receiving the token revoke request, the application server 122 requests 370 the authentication server 124 to revoke the corresponding token. Responding to the request, the authentication server 124 revokes 380 the corresponding token. In another embodiment, the first party 110 revokes the current token by sending a token revoke request to the second party 120 through the cell phone 214 via the GSM network, the Internet, the web server 123, and application server 122. The application server 122 then forwards the request to the authentication server 124.

Upon reading this disclosure, those of skill in the art will appreciate still additional alternative structural and functional designs for a system and a process for online token creation and delivery for secured electronic communication between parties through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A computer-implemented method to create and deliver token, the method comprising:
receiving a request from a user to generate a token;
transmitting a retrieval link to the user through a first network;
receiving a retrieval request, the request containing the retrieval link;
generating the token with an embedded token application and token dataset, the token dataset being associated with the user; and
transmitting to the user the token with the embedded token application and token dataset through a second network, the second network being different from the first network.

2. The method of claim 1, wherein the first network is one from a group consisting of a Global System for Mobile communication network, a Code Division Multiple Access network, a Time Division Multiple Access network, a General Packet Radio Service network, a Wideband Code Division Multiple Access network, a Time Division Synchronous Code Division Multiple Access network, and a Universal Mobile Telephone System.

3. The method of claim 2, wherein sending the retrieval link comprises sending the retrieval link through the Short Message Service through the Global System for Mobile communication network.

4. The method of claim 1, wherein the second network is the Internet.

5. The method of claim 4, wherein transmitting to the user the token with the embedded token application and token dataset comprises transmitting to the user the token with the embedded token application and token dataset through a Secure Socket Layer through the Internet.

6. The method of claim 1, wherein transmitting the retrieval link to the user comprises transmitting the retrieval link and a private key to the user through the first network, and wherein transmitting the token with the embedded token application and token dataset comprises sending the token with the embedded token application and token dataset encrypted with a public key, the private key being paired with the public key.

7. The method of claim 1, wherein the retrieval link expiring after a predetermined time period.

8. A computer-implemented communication method, comprising:
transmitting a request to generate a token to a server;
receiving a retrieval link through a first network;
transmitting a retrieval request to the server, the request containing the retrieval link; and
receiving the token with an embedded token application and token dataset from the server through a second network, the second network being different from the first network.

9. The method of claim 8, wherein receiving the retrieval link comprises receiving the retrieval link through the Short Message Service through the Global System for Mobile communication network.

10. The method of claim 8, wherein the second network is the Internet.

11. The method of claim 8, wherein receiving the retrieval link comprises receiving the retrieval link and a private key through the first network, and wherein receiving the token with the embedded token application and token dataset comprises receiving the token with the embedded token application and token dataset encrypted with a public key, the private key being paired with the public key, the method further comprising:
decrypting the encrypted token with the embedded token application and token dataset with the private key.

12. The method of claim 8, wherein the retrieval link expiring after a predetermined time period.

13. An electronic communication apparatus comprising:
a processor; and
a memory structured to store instructions executable by the processor, the instructions corresponding to:
receiving a request from a user to generate a token;
transmitting a retrieval link to the user through a first network;
receiving a retrieval request, the request containing the retrieval link;
generating the token with an embedded token application and token dataset, the token dataset being associated with the user; and
transmitting to the user the token with the embedded token application and token dataset through a second network, the second network being different from the first network.

14. The electronic communication apparatus of claim 13, wherein transmitting the retrieval link to the user comprises transmitting the retrieval link and a private key to the user through the first network, and wherein transmitting the token with the embedded token application and token dataset comprises sending the token with the embedded token application and token dataset encrypted with a public key, the private key being paired with the public key.

15. An electronic communication apparatus comprising:
a processor; and
a memory structured to store instructions executable by the processor, the instructions corresponding to:
transmitting a request to generate a token to a server;
receiving a retrieval link through a first network;
transmitting a retrieval request to the server, the request containing the retrieval link; and
receiving the token with an embedded token secret and token dataset from the server through a second network, the second network being different from the first network.

16. The electronic communication system of claim 15 wherein receiving the retrieval link comprises receiving the retrieval link and a private key through the first network, and wherein receiving the token with the embedded token application and token dataset comprises receiving the token with the embedded token application and token dataset encrypted with a public key, the private key being paired with the public key, the instructions further corresponding to:
decrypting the encrypted token with the embedded token application and token dataset with the private key.

17. An electronic communication system comprising:
a receiver configured to receive an initiation request to generate a token from a user and configured to receive a retrieval request, the request containing a retrieval link, the retrieval link expiring after a predetermined time period;
a token generator configured to generate a token with an embedded token application and token dataset, the token dataset being associated with the user; and
a transmitter configured to transmit the retrieval link to the user through a first network, and configured to transmit to the user the token with the embedded token application and token dataset through a second network, the second network being different from the first network.

18. A computer program product for use in conjunction with a computer system, the computer program product comprising a computer readable storage medium and a computer program mechanism embedded therein, the computer program mechanism including:
instructions for receiving a request from a user to generate a token;
instructions for transmitting a retrieval link to the user through a first network;
instructions for receiving a retrieval request, the request containing the retrieval link;
instructions for generating the token with an embedded token application and token dataset, the token dataset being associated with the user; and
instructions for transmitting to the user the token with the embedded token application and token dataset through a second network, the second network being different from the first network.

19. The computer program product of claim 18, wherein instructions for transmitting the retrieval link to the user comprises instructions for transmitting the retrieval link and a private key to the user through the first network, and wherein instructions for transmitting the token with the embedded token application and token dataset comprises instructions for sending the token with the embedded token application and token dataset encrypted with a public key, the private key being paired with the public key.

20. A computer program product for use in conjunction with a computer system, the computer program product comprising a computer readable storage medium and a computer program mechanism embedded therein, the computer program mechanism including:
instructions for transmitting a request to generate a token to a server;
instructions for receiving a retrieval link through a first network;
instructions for transmitting a retrieval request to the server, the request containing the retrieval link; and
instructions for receiving the token with an embedded token application and token dataset from the server through a second network, the second network being different from the first network.

21. The computer program product of claim 20, wherein instructions for receiving the retrieval link comprises instructions for receiving the retrieval link and a private key through the first network, and wherein instructions for receiving the token with the embedded token application and token dataset comprises instructions for receiving the token with the embedded token application and token dataset encrypted with a public key, the private key being paired with the public key, the method further comprising:
instructions for decrypting the encrypted token with the embedded token application and token dataset with the private key.
